(19) United States
(12) Patent Application Publication
(10) Pub. No.: US 2021/0183270 A1
(43) Pub. Date: Jun. 17, 2021

(54) METHOD AND SYSTEM FOR BREATHING MONITORING

(71) Applicant: IEE INTERNATIONAL ELECTRONICS & ENGINEERING S.A., Echternach (LU)

(72) Inventors: Dimitri TATARINOV, Trier (DE); Claude WATGEN, Moutfort (LU); Peter LARSEN, Bereldange (LU); Una KARAHASANOVIC, Trier (DE); Franck LEMOINE, Launstroff (FR)

(21) Appl. No.: 16/758,692

(22) PCT Filed: Oct. 25, 2018
(86) PCT No.: PCT/EP2018/079231

§ 371 Date: Apr. 23, 2020

(30) Foreign Application Priority Data
Oct. 26, 2017 (LU) LU 100 498
Dec. 22, 2017 (LU) LU 100 591

(51) Int. Cl. G09B 23/32

(52) U.S. Cl. CPC G09B 23/32

(57) ABSTRACT

A system for simulating a breathing motion of a living being. The system includes a manikin representing the living being and having a chest region and an abdominal region. For reliably and realistically verifying the functionality of a breathing monitoring device, the system further includes: an actuator system configured to generate a chest motion in the chest region and an abdominal motion in the abdominal region; and a control unit configured to independently control the chest motion and the abdominal motion to represent the breathing motion.

### TECHNICAL FIELD

The present invention relates to a system for simulating a breathing motion of a living being. It further relates to a method for programming such a system and to a method for testing a monitoring device for monitoring a breathing motion of a living being.

### BACKGROUND

Various methods for monitoring breathing of a person are known in the art. Such monitoring may be performed in order to assess the fitness of an athlete, to assess fatigue of a driver or pilot, to monitor sleeping behavior or to identify breathing anomalies. Some of these methods are contact methods, which e.g. require the person to wear a mask and/or stretch resistance bands. Apart from these, there are non-contact methods. The latter methods are mostly radar-based and use one or several radar transceivers. Beside this, there are methods which rely on optical recognition of a breathing motion. These methods may e.g. be used in automotive applications to monitor the health status or the fatigue of a driver.

In order to detect certain breathing disorders, it is sufficient to monitor chest displacement as a function of time to identify any changes in the breathing frequency or amplitude or sudden stops in breathing (apnea). However, in some cases, it is necessary to simultaneously monitor chest and abdominal displacement, since a significant degree of asynchrony between abdominal and pulmonary motion provides an indication of certain diseases such as bronchopulmonary dysplasia, obstructive sleep apnea, upper or lower airway obstruction, chronic lung disease in prematurely born infants, certain neuromuscular diseases and in general abnormalities in the thoraco-abdominal motion, which cannot be diagnosed by looking at the chest displacement signal alone. The chest displacement and the abdominal displacement can be monitored individually e.g. by two separate stretch resistance bands or by a radar-based system which irradiates both the chest and the abdomen of a person.

Irrespective of the employed measurement method (contact or non-contact), it is necessary to verify the proper function of the monitoring device, e.g. during development of a new device or during calibration or testing. One option is to monitor the breathing motion of a test person. However, such a process can be tedious for the test person, especially if a large number of devices need to be tested. Also, any measurements by the monitoring device need to be verified either by an additional detection system which is known to function properly or by examination of the test person by a physician or other qualified person. Furthermore, if breathing disorders are to be detected, it is difficult to test or calibrate every single monitoring device on a patient suffering from such disorder. Above all, it would be desirable for a testing or calibration process that a certain breathing motion could be presented to the monitoring device in a reproducible and robust way. This, however, is hardly possible with a test person.

### SUMMARY

It is an object of the present invention to provide means for reliably and realistically verifying the functionality of a breathing monitoring device. The object may be achieved by a system and methods according to the claims.

In one aspect, the present invention provides a system for simulating a breathing motion of a living being. It is understood that breathing of a living being is a rather complex process if all aspects and every single moving body part is considered. To this respect, the term “simulating” is not to be construed in a limiting way that every detail of the breathing process is imitated. Rather, as will become apparent in the following, the simulation is realistic to a certain extent that is necessary for the application in view.

The system comprises a manikin having a general outward appearance and haptic properties of the living being and having a chest region and an abdominal region. The manikin, which may also be referred to as a dummy or a puppet, resembles the living being or at least a part of the living being. The size and shape of the manikin and portions thereof resemble those of the living being. A certain degree of abstractness is normally present and depends on the application in view. The manikin does not need to represent the entire body of the living being, but may e.g. be limited to a torso or a shape resembling and/or having similar properties to a torso. Preferably, the manikin comprises additional portions like a head, arms and/or legs. It has a chest region and an abdominal region, which of course corresponds to the respective regions in the body of the living being. In other words, the chest region is disposed above the abdominal region on the torso.

The system further comprises an actuator system configured to generate a chest motion in the chest region and an abdominal motion in the abdominal region. The actuator system comprises at least one actuator, normally at least two actuators and is configured to generate the chest motion and the abdominal motion. Each motion is associated with a (chest/abdominal) movable element that is disposed in the respective region. More specifically, the actuator system is configured to generate the chest motion and the abdominal motion individually or independently from each other, so that at least parameter of the chest motion can be different from the abdominal motion. As will be explained further below, the actuator system may be disposed within the manikin or at least partially outside the manikin. Which configuration is chosen can depend on the respective application and the type of actuator.

The system further comprises a control unit configured to independently control the chest motion and the abdominal motion to represent the breathing motion. The control unit is connected by wire and/or wirelessly to the actuator system and controls the actuator system. It is understood that the control unit may comprise a single unit or several separate units, e.g. with one unit located in the proximity of each actuator. Further, the control unit may at least partially be software-implemented. The control unit may be disposed within the manikin or at least partially outside of the manikin. It may comprise or be connected to a terminal for manual input by a user as well as an interface for connection to another device, for input and/or output of data and/or commands. Also, it may comprise or be connected to a display for a user. At least a part of the control unit could be implemented by a conventional personal computer.

The control unit independently controls the chest motion and the abdominal motion, wherein “independently” is to be understood as “separately” or “individually”, which means that the control unit can adjust at least one parameter of the chest motion independently of the abdominal motion. In other words, the control unit can influence the chest motion without influencing the abdominal motion at the same time (and vice versa). The chest and abdominal motion are controlled to represent the breathing motion, which means that they are controlled to at least resemble a realistic motion of the chest region and the abdominal region of the living being. This may pertain to a variety of parameters of the chest motion and abdominal motion, respectively, including amplitude, frequency, phase but also waveform and/or direction. One of the chest motion and the abdominal motion are normally oscillating and/or periodic for certain time intervals, it is possible that at least one of these motions is temporarily non-periodic and/or non-oscillating.

The inventive system provides a realistic simulation of breathing behavior, because usually the abdominal motion and the chest motion of a living being differ from each other at least to some degree. For instance, these two motions are rarely completely in phase with each other (although the phase lag may be small). In particular, the differences may depend on the health state of the living being. As the two motions are controlled independently, they may at least look and/or feel realistic as compared to the actual breathing motion of the living being. This may for example be beneficial for simple applications where the manikin is used as a toy for a child, in which case the manikin could resemble a pet or a baby. Of course, for these applications, the manikin should have an outward appearance that is highly realistic, comprising a head and limbs and a surface material resembling the haptic properties of the living being.

More important, the manikin can be used to test and/or calibrate monitoring devices which are used to monitor the breathing behavior of a living being. This may include devices used in aerospace or automotive applications for monitoring the fatigue and/or health of a pilot or driver. Other applications are for monitoring devices in medical or sports applications. For any of these monitoring devices, the inventive system can be used to provide a realistic, reproducible and robust input. For these applications, the outward appearance of the manikin does not have to be highly realistic but normally should at least resemble the size and shape of the living being.

The control unit is normally connected to a memory unit or comprises a memory unit, which may be any type of volatile or non-volatile memory. This memory unit can be used to store data representing one or several types of breathing motion and could be based on real measurements on a living being or could be synthetic.

In some applications, the living being may be an animal, e.g. when the manikin is used as a toy, demonstration object or the like, or for veterinary applications. According to another embodiment, the living being is a human being. In other words, the manikin resembles a human body or at least a part thereof. The manikin may represent an adult, a child or a baby, which may be useful when testing the applicability of monitoring systems to human beings of different size and age.

Preferably, the control unit is configured to control a phase lag between the chest motion and the abdominal motion. In general, the chest motion and the abdominal motion of a living being occur at the same frequency, but not necessarily at the same phase. That is, in particular depending on the health of the living being, the phase lag (or phase difference) between the chest motion and the abdominal motion may differ. Since this phase lag can be used to diagnose certain breathing disorders, monitoring devices should be able to determine this phase lag and optionally indicate a possible breathing disorder associated with it. Therefore, if the manikin is used to test or calibrate a monitoring device, it is highly desirable that a phase lag between the chest motion and the abdominal motion can be controlled. Normally, this implies that the control unit is configured to adjust the phase lag to different values.

It is also preferred that the control unit is configured to control an amplitude of the chest motion and/or the abdominal motion. In particular, the amplitudes may be controlled independently of each other. The amplitude of the respective motion may also indicate a level of fatigue, level of physical stress and/or a breathing disorder. Therefore, the ability to control the amplitude is especially important for testing monitoring devices. However, it may also be advantageous for applications as a toy etc.

According to another preferred embodiment, the control unit is configured to control a frequency of the chest motion and/or the abdominal motion. It is conceivable that the respective frequencies can be controlled independently of each other, but they are normally identical for a living being. The frequency may also be used to determine the level of fatigue or physical stress of a living being, wherefore it is advantageous for the system to simulate different frequencies as a realistic input for a monitoring device.

In one embodiment, each of the chest motion and the abdominal motion can be described as a (e.g. one-dimensional or multi-dimensional) oscillation of a movable element along a fixed path. According to a more complex embodiment, the control unit can be configured to control a direction of the chest motion and/or the abdominal motion. In such an embodiment, the actuator system is configured to move at least one movable element in the chest region or the abdominal region independently along at least two different directions, e.g. perpendicular and tangential to the outer surface of the manikin.

While the above paragraphs referred to “a” phase lag, amplitude, frequency or direction, respectively, this is not to be construed in such a way that the respective motion needs to be sinusoidal. In fact, both the chest motion and the abdominal motion may have a more complex waveform that could—at least for certain time intervals—be regarded as a superposition of a basic oscillation and upper harmonics. The motion may even differ considerably from a pure sinusoidal oscillation. In such a case, the control unit may be configured to individually control the amplitude, frequency, direction and phase lag of each of these oscillations individually, thus being able to provide different waveforms. Also, the control unit is normally configured to vary at least one parameter like phase lag, amplitude, frequency or direction as a function of time.

According to a preferred embodiment, at least one of the chest motion and the abdominal motion is a motion of an outer surface of the manikin. For the most part, this is desirable for testing a monitoring device which employs an non-contact optical method or a contact, e.g. expansion-belt based method. If the abdominal/chest motion is a motion of an outer surface, this motion can be recognized optically (e.g. by the naked eye) and it can also be used to simulate an expansion of the chest/abdomen. Normally, at least a component of the motion is perpendicular to the outer surface. Beside this, a motion of the outer surface can be used to create a realistic optic/haptic appearance of e.g. a toy.

Since many modern monitoring devices are optical or radar-based, it is preferred that the inventive system allows for optical and/or radar-based detection of each of the chest and/or abdominal motion. Therefore it is preferred that at least one of the chest motion and the abdominal motion is a motion of an optically detectable and/or radar-reflective surface. In other words, the actuator system is configured to move a movable element that comprises an optically detectable and/or radar-reflective surface. In this context, the radar-reflective surface could be the surface of an element underneath the outer surface of the manikin. Preferably, the optically detectable and/or radar-reflective surface is an outer surface of the manikin or is fixedly connected to the outer surface (e.g. with a cover layer for optical appearance or haptic properties). In order to be effectively radar-reflective, the radar cross-section of the respective surface should at least correspond to the radar cross-section of the chest or abdomen, respectively, of the living being. In order to achieve such a cross-section, a material having a similar radar reflectivity as the tissue of the living being could be used. However, it is conceivable to divert from this concept e.g. by making the radar cross-section bigger (e.g. by using a metal foil in the movable element, in order to make monitoring under test conditions easier, or by making the radar cross-section smaller, in order to simulate a “lower limit” of detection for the monitoring device. Of course, the reflectivity depends to some extent on the radar frequency of the monitoring device, so that depending on this frequency, different materials or surface layers of different thickness could be used. The term “optically detectable” in this context is to be understood regarding the detection method of the monitoring device in view. Normally, the optically detectable surface is light-reflective, thereby allowing active or passive optical detection. However, at least portions of the surface could have a minimal light-reflectivity and be effectively light-absorbing, in which case the surface and the respective motion could still be optically detectable e.g. with respect to a lighter background. Normally, the optically detectable surface is an outer surface of the manikin.

The actuator system may be realized in several different ways. In particular, it may comprise at least one mechanical actuator, hydraulic actuator, pneumatic actuator and/or electrodynamic actuator. Mechanical and electrodynamic actuators are especially suitable for being disposed in the manikin itself. These types of actuators may preferably act directly on a movable element that is used for detection of the respective motion, e.g. an outer surface of the manikin, and optically detectable surface and/or a radar-reflective surface. One example would be a servomotor that is coupled, optionally via a simple transmission, to the respective surface. Another example would be a piezoelectric actuator. Pneumatic and hydraulic actuators may comprise a pump which is connected by a conduit to an inflatable bellows or the like. In this case, a portion of the outer surface of the manikin can be connected to the bellows so that it moves depending on whether the bellows is inflated or deflated. In case of these actuators, which may also be referred to as indirectly acting on the movable element, at least a part of the actuator, e.g. a pump, could be disposed outside the manikin with a conduit for the work fluid extending from the pump into the inside of the manikin where a bellows or the like is disposed. It is understood that the actuator system normally comprises at least two actuators and that different types of actuators may be combined in a single inventive system.

In order to test the functionality of a monitoring device regarding e.g. breathing anomalies, it is in principle sufficient to provide the abdominal motion and the chest motion. However, for some applications it can be useful if the actuator system is configured to generate at least one motion in a third region of the manikin which is different from the abdominal region and the chest region. For example, this may help to test the monitoring device under more realistic conditions, because when examining a living being, the chest and the abdomen are normally not the only moving body parts. Especially for non-contact monitoring devices, e.g. radar-based monitoring devices, motion of other body regions could be a possible source of errors if these regions are also irradiated. Therefore, generating a motion of such a third region helps to test whether the functionality of the monitoring device is impaired. Apart from this, there may be other reasons to provide such a motion of a third region, like to make a manikin appear more realistic to the human eye, e.g. if the manikin is used as a toy.

In particular, at least one third region can be a limb region or a head region. A limb region is a region of the manikin that belongs to a leg or arm of the manikin. This may e.g. be a shoulder, an upper arm, a lower arm, and upper thigh or lower thigh, a hand or a foot. The actuator system may, for example, be configured to move the respective element about a joint, e.g. move the arm about a shoulder joint. The head region belongs is associated with a head and may refer to the entire head, the neck or a part of the head e.g., responding to a mouth of the living being. The actuator system may be configured to move the head about a joint or hinge in the neck. While it is possible to simulate motion which is independent of the breathing motion, motion of the limb region and/or of the head region may also be correlated to the breathing motion, thereby simulating that the head and/or a limb may also undergo a certain amount of displacement or motion as breathing occurs.

Apart from generating motions of certain parts of the manikin with respect to each other, the actuator system may be configured to generate a motion of at least a major part of the manikin with respect to a stationary reference frame. This may also be referred to as a collective motion of the entire manikin or at least a major part of the manikin with respect to the reference frame. The reference frame may e.g. be represented by a stationary floor (on which a monitoring device could be placed). The manikin could be placed on a seat or platform that is movable with respect to the stationary reference frame by one or several actuators. The motion of the seat or platform would then result in a motion of the entire manikin (or at least a major part of it). Alternatively, the manikin itself could comprise at least one actuator that is configured to generate a collective motion of the manikin. E.g., an actuator could be disposed inside the torso (or another part of the manikin) to generate an oscillating motion, e.g. a vibration. The motion with respect to the reference frame can be used to simulate a similar motion of a human body inside a vehicle (a car, plane or the like) when the vehicle is in motion. Such motion may be caused by vibration due to the vehicle's engine, by acceleration processes or the like. Likewise, a similar motion could occur even within a building e.g. due to vibrations induced by trains passing by or the like. Any such motion could potentially impair the function of a monitoring system, so it is reasonable to simulate such motion when testing the monitoring system.

The inventive system may not be limited to simulating breathing behavior. For example, it may also be used to simulate the heartbeat or pulse of the living being. According to such an embodiment, the control unit is configured to control at least one motion to represent a pulse of the living being. In this context, there are basically two options, which may be used simultaneously or alternatively. One option is that a dedicated actuator is used to simulate a pulse, e.g. in a third region as mentioned above. This could be, for instance, an actuator disposed in the neck or in an arm of the manikin. It is also possible that a dedicated actuator for simulating the pulse is disposed in the chest region and/or the abdominal region. Another option is that when actuator is used to simulate the breathing motion and the pulse at the same time, like a seismographic movement of the body surface. In other words, the overall chest/abdominal motion may be a superposition of breathing and pulse, which would be distinguishable, among others, by their frequency, amplitude and relative phase. If a dedicated actuator is used, it is possible to employ any type of actuator that is suitable for simulating the breathing motion. Normally, the motion representing the pulse is performed by an outer surface of the manikin. The control unit is normally also configured to control a frequency and/or an amplitude of the pulse.

According to another embodiment, the control unit is configured to control at least one motion to represent a transient motion of the living being. This transient motion may in particular be non-periodic and/or non-oscillating. It may in particular represent nodding, coughing, yawning, hiccup, sneezing, regurgitation, talking, muscle twitching or any motion of a limb or part thereof. Any of these transient motions may be superimposed on the breathing motion represented by the chest motion and/or the abdominal motion or the breathing motion may be interrupted temporarily by this transient motion. For example, when a person is talking, the normal breathing pattern is interrupted. However, a breathing monitoring device should be able to identify this interruption and disregard it e.g. when identifying a breathing disorder. Therefore, a realistic test for a monitoring device should include a simulation of such transient motion. Of course, these transient motions are not limited to the chest region and the abdominal region, but may additionally or exclusively be located in other regions, e.g. a head region or a limb region. These transient motions may be complex, e.g. they may comprise simultaneous motions in different regions of the manikin or of different body parts in a single region (e.g. upper arm, lower arm and hand). Any such complex motion provides a more realistic simulation of a living being as well as a more realistic test for a monitoring device.

In another aspect, the invention further provides a method for programming a system as described above. The method comprises at least the following steps: in a first step, a monitoring device monitors a breathing motion of a living being. The monitoring device may apply any kind of contact or non-contact measurement method to monitor the breathing motion. This may e.g. be based on an expansion belt, an optical (image recognition) method or a radar-based method. The measurement should at least be able to differentiate between a chest motion and an abdominal motion of the living being. In a second step, which may at least partially be performed simultaneously with the first step, data representing the breathing motion are stored in a memory unit that is accessible by the control unit. Before the data are stored in this memory unit, some intermediate storing and/or data conversion may be performed. For example, the monitoring device may not be adapted to provide a data format that is suitable as control data for the control unit. The memory unit may be permanently connected to the control unit by a wired connection or it may be connectable by a wireless or wired connection, i.e. the memory unit and the control unit may comprise interfaces enabling such a connection. Depending on the embodiment, the memory unit may be permanently integrated in the monitoring device. In such a case, the system could even have no dedicated memory unit for control data at all and could entirely rely on the external memory unit in the monitoring device.

It is understood that preferred embodiments of this method correspond to those of the above described system. For example, the monitoring device may be adapted to detect a motion corresponding to a pulse of the living being, a transient motion and/or a collective motion of the living being with respect to a stationary reference frame. In this case, the data recorded in the memory unit would also represent the pulse, the transient motion and/or the collective motion.

In yet another aspect, the invention further provides a method for testing a monitoring device for monitoring a breathing motion of a living being. In a first step of the method, an inventive system as described above is provided. In a second step, the monitoring device is disposed in a predefined detection position relative to the manikin. Of course, the detection position corresponds to a detection position that would be suitable for monitoring the breathing motion of a living being represented by the manikin. In case of a contact monitoring method, disposing the system also comprises e.g. applying at least one expansion belt to the manikin. Normally, one expansion belt is applied to the chest region and another expansion belt is applied to the abdominal region. In case of a radar-based monitoring device, one radar transceiver could be directed at the chest region and another radar transceiver could be directed at the abdominal region. In another step, the actuator system generates the chest motion and the abdominal motion and the control unit independently controls the chest motion and the abdominal motion to represent the breathing motion. In other words, the system simulates the breathing motion. In another step, which is normally performed simultaneously, the monitoring device detects the chest motion and the abdominal motion. Of course, additional steps may be performed, like evaluating the chest motion and the abdominal motion, possibly indicating a breathing disorder, or storing data representative of the breathing motion.

Preferred embodiments of this method correspond to those of the above described system. For example, the actuator system and/or the control unit may be adapted to simulate a pulse, a transient motion and/or a collective motion of the living being, in which case the monitoring device may detect a motion corresponding to the pulse, the transient motion and/or the collective motion.

### BRIEF DESCRIPTION OF THE DRAWINGS

Further details and advantages of the present invention will be apparent from the following detailed description of not limiting embodiments with reference to the attached drawing, wherein:

FIG. 1 shows a schematic representation of an inventive system for simulating a breathing motion;

FIG. 2 is a schematic representation illustrating a method for programming the system of FIG. 1; and

FIG. 3 is a schematic representation illustrating a method for testing a monitoring device for breathing monitoring.

### DETAILED DESCRIPTION

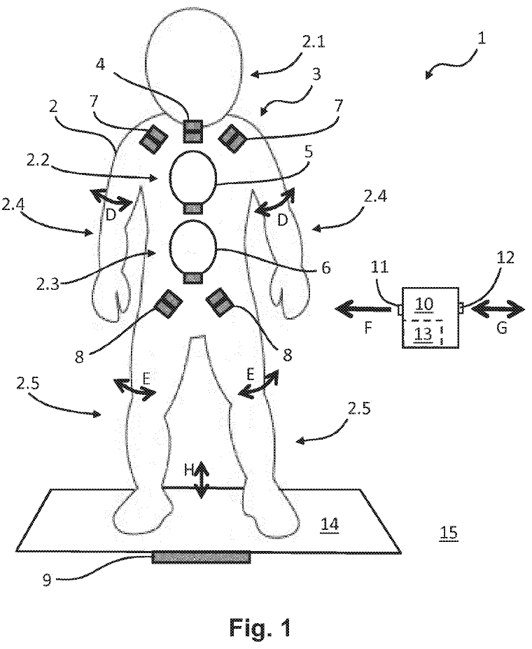

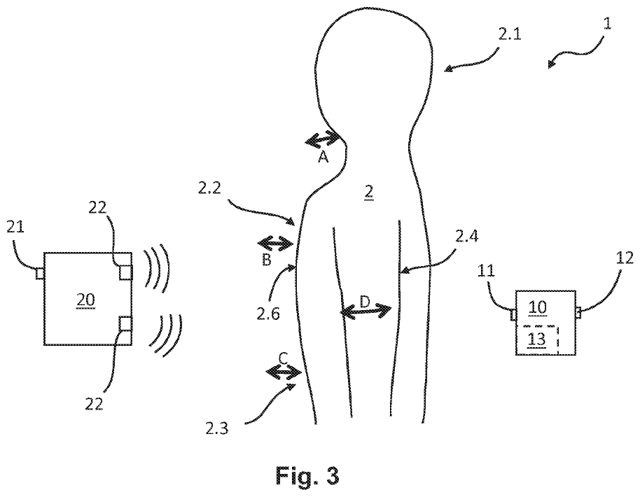

FIG. 1 schematically shows an inventive system 1 for simulating a breathing motion (and other motions) of a human being, e.g. an infant or adult. The system 1 comprises a manikin 2, which resembles the human being in size and shape. As can be seen in FIG. 1, the manikin 2 comprises a head region 2.1, a chest region 2.2, an abdominal region 2.3, two arm regions 2.4 and two leg regions 2.5. The system 1 further comprises a actuator system 3, which in this embodiment is entirely disposed inside the manikin 2. The actuator system 3 comprises a head actuator 4, a chest actuator 5, an abdominal actuator 6, two arm actuators 7 and two leg actuators 8. It is understood that the actuators 4-8 are shown schematically and that their size, shape and position may differ from reality. While the head actuator 4, the arm actuators 7 and the leg actuators 8 may e.g. be electrodynamic actuators, the chest actuator 5 and the abdominal actuator 6 can be pneumatic actuators comprising a pump and an expandable bellows. When the chest actuator 5 is operated to inflate or deflate its bellows, this gives rise to an chest motion B (see also FIG. 3) of an outer surface 2.6 of the manikin 2 in the chest region 2.2. Likewise, when the abdominal actuator 6 is operated to inflate or deflate its bellows, this causes an abdominal motion C of the outer surface 2.6 in the abdominal region 2.3.

When the head actuator 4 is operated, this causes a head motion A in the head region 2.1, which may e.g. correspond to a tilting of the head. When an arm actuator 7 is operated, this causes arm motion D in the respective arm region 2.4, which may correspond to a pivoting of the arm about a shoulder joint. When a leg actuator 8 is operated, this causes a leg motion E in the respective leg region 2.5, possibly corresponding to a pivoting of the leg about a pelvic joint.

Furthermore, the manikin 2 is placed on a plate 14 that is movable by a plate actuator 9 (which may also be an electrodynamic actuator) with respect to a stationary reference frame 15 (e.g. a floor). When the plate actuator 9 is operated, the plate 14 and the entire manikin 2 are moved with respect to the reference frame 15. This corresponds to a collective motion H of the manikin 2.

All actuators 4-9 are controlled by a control unit 10, which by way of example is shown outside of the manikin 2, but may also be at least partially integrated into the manikin 2. Although it is schematically shown as a single block, the control unit 10 may comprise several distinct physical components. At least a part of the control unit 10 may e.g. be a conventional personal computer. The control unit 10 has a first interface 11 for outputting control signals F to the actuators 4-9 either wirelessly or by wire. It also has a second interface 12 for exchanging data G with an external device. Further, it comprises a memory unit 13 for storing data which correspond to a motion sequence of the actuators 4-9. In particular, these data correspond to a breathing motion that is simulated by the chest actuator 5 and the abdominal actuator 6.

The control unit 10 is configured to control each of the actuators 4-9 individually. In particular, it can control each of the chest actuator 5 and the abdominal actuator 6 to individually adjust an amplitude, a frequency, a relative phase and/or a waveform of the chest motion B and the abdominal motion C. In order to provide a realistic simulation of a breathing motion, the frequency is normally the same for the chest motion and the abdominal motion. However, in particular the relative phase or, in other words, the phase lag between the chest motion B and the abdominal motion C can be adjusted by the control unit 10 e.g. in order to simulate certain breathing disorders.

Apart from controlling the chest motion B and the abdominal motion C to represent a breathing motion of the human being 30, the control unit 10 may also control the head actuator 4 to simulate a certain head motion A, the arm actuators 7 to simulate certain arm motion D, the leg actuators 8 to simulate a certain leg motion E and the plate actuator 9 to simulate a certain collective motion H of the manikin. Each of these motions A, D, E, H may follow a random pattern or a certain predefined pattern represented by data stored in the memory unit 13. Also, the control unit 10 may control at least one motion A-E to represent a pulse of the human being. Such a pulse may e.g. be superimposed on the breathing motion performed by the chest actuator 5 and the abdominal actuator 6. It is understood that the pulse normally occurs at a different frequency and with a much smaller amplitude than the breathing motion. However, the pulse could also be simulated by one or several dedicated actuators that are also controlled by the control unit 10.

The control unit 10 is configured to control at least one motion A-E to represent a transient motion of the living being. This transient motion may in particular be non-periodic and/or non-oscillating. It may in particular represent nodding, coughing, yawning, hiccup, sneezing, regurgitation, talking, or muscle twitching. Any of these transient motions may be superimposed on the breathing motion represented by the chest motion and/or the abdominal motion or the breathing motion may be interrupted temporarily by this transient motion. Also, any of these motions can be superimposed on the collective motion H.

While it is possible that the motion sequences of the manikin 2 follow predefined data stored in the memory unit 13, it is also conceivable that a user can change any of the motion parameters in real time e.g. via the second interface 12 or via an additional interface not shown in FIG. 1.

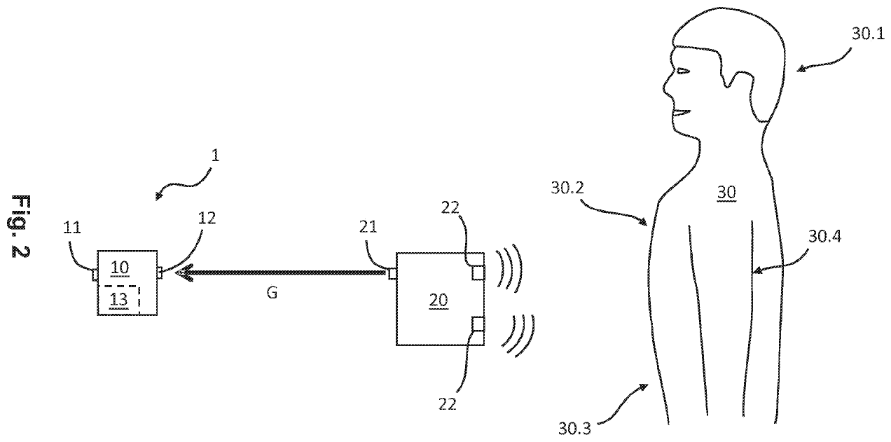

FIG. 2 illustrates, by way of example, a method for programming the system 1 shown in FIG. 1. For sake of simplicity, the manikin 2 is omitted in FIG. 2 and only the control unit 10 with its interfaces 11, 12 and the memory unit 13 is shown. Schematically shown is a human being 30, or rather the upper part of its body. A monitoring device 20 for breathing monitoring is disposed in a predefined measurement position in front of the human being 30. The monitoring device 20 has two radar transceivers 22, which are directed at a chest region 30.2 and an abdominal region 30.3 of the human being 30. By receiving and analyzing radar signals reflected from the respective region 30.2, 30.3, the monitoring device 20 generates data G representative of a breathing motion of the human being 30. These data G can be sent (either wirelessly or by wire) via a third interface 21 of the monitoring device 22 the second interface 12 of the control unit 10 where they can be stored in the memory unit 13. Optionally, some data conversion and/or intermediate storing of the data can be performed.

It will be understood that the monitoring device 20 could have a different transceiver configuration and that instead of a radar-based measurement, the breathing motion could also be detected optically by image recognition, by expansion belts located in the chest region 30.2 and the abdominal region 30.3 or by any other measurement technique. The monitoring device 20 could also monitor the motion of other regions, e.g. a head region 30.1 or an arm region 30.4 of the human being 30. Likewise, the monitoring device 20 could monitor a collective motion of the entire body of the human being 30.

FIG. 3 schematically illustrates a method for testing a monitoring device 20, which in this example is identical to the monitoring device 20 shown in FIG. 2. However, it could be a different type, possibly relying on a different detection method (e.g. optical or expansion-belt based). In a first step of the testing method, the system 1 at is shown in FIG. 1 is provided. After that, the monitoring device 20 is disposed in a predefined detection position relative to manikin 2. The detection position corresponds to a detection position that would be suitable for detecting breathing motion of the human being 30. The control unit 10 then controls the chest motion B and the abdominal motion C to represent a breathing motion, normally based on control data stored in the memory unit 13. The radar transceivers 22 of the monitoring device 20 irradiate the chest region 2.2 and the abdominal region 2.3 of the manikin 2 and by receiving reflected radar signals, the monitoring device 20 detects the chest motion B and the abdominal motion C. Detection is facilitated by the fact that an outer surface 2.6 of the manikin 2 is radar-reflective, whereby the chest region 2.2 and the abdominal region 2.3 have a radar cross-section that is similar to the chest region 30.2 and the abdominal region 30.3 of the human being 30.

Optionally, the control device 10 may control the head motion A, the arm motion D, the leg motion E and/or the collective motion H. Apart from simulating the breathing motion, it may also simulate a pulse or some transient motion, that can represent nodding, coughing, yawning, hiccup, sneezing, regurgitation, talking or muscle twitching. These motions can also be detected and identified by the monitoring device 20.

The system 1 allows great number and/or a variety of monitoring devices 20 to be tested in a realistic and reproducible way. In other words, the system 1 can simulate the same motion over and over again. It is understood that the control data in the memory device 13 can be copied and transferred to other control devices 10, whereby motion data recorded like in FIG. 2 can be used for an unlimited number of simulation systems 1. Also, the data stored in the memory unit 13 do not have to be data recorded in a real measurement, but could be synthetic.

1. A system for simulating a breathing motion of a living being, the system comprising:
a manikin having an outward appearance and haptic properties of the living being and having a chest region and an abdominal region;
an actuator system configured to generate a chest motion (B) in the chest region and an abdominal motion in the abdominal region; and
a control unit configured to independently control the chest motion and the abdominal motion to represent the breathing motion.

2. The system of claim 1, wherein the living being is a human being.

3. The system of claim 1, wherein the control unit is configured to control a phase lag between the chest motion and the abdominal motion.

4. The system of claim 1, wherein the control unit is configured to control an amplitude of the chest motion and/or the abdominal motion.

5. The system of claim 1, wherein the control unit is configured to control a frequency of the chest motion and/or the abdominal motion.

6. The system of claim 1, wherein the control unit is configured to control a direction of the chest motion and/or the abdominal motion.

7. The system of claim 1, wherein at least one of the chest motion and the abdominal motion is a motion of an outer surface of the manikin.

8. The system of claim 1, wherein at least one of the chest motion and the abdominal motion is a motion of an optically detectable and/or radar reflective surface.

9. The system of claim 1, wherein the actuator system comprises at least one mechanical actuator, hydraulic actuator, pneumatic actuator and/or electrodynamic actuator.

10. The system of claim 1, wherein the actuator system is configured to generate at least one motion in a third region of the manikin which is different from the chest region and the abdominal region.

11. The system of claim 1, wherein the actuator system is configured to generate a motion of at least a major part of the manikin with respect to a stationary reference frame.

12. The system of claim 1, wherein the control unit is configured to control at least one motion to represent a pulse of the living being.

13. The system of claim 1, wherein the control unit is configured control at least one motion to represent a transient motion of the living being.

14. A method for programming a system according to claim 1 the method comprising:
a monitoring device monitoring a breathing motion of a living being; and
storing data representing the breathing motion in a memory unit that is accessible by the control unit.

15. A method for testing a monitoring device for monitoring a breathing motion of a living being, the method comprising:
providing a system according to claim 1,
disposing the monitoring device in a predefined detection position relative to the manikin;
the actuator system generating the chest motion and the abdominal motion and the control unit independently controlling the chest motion and the abdominal motion to represent the breathing motion; and
the monitoring device detecting the chest motion and the abdominal motion.
